(19) United States
(12) Patent Application Publication
(10) Pub. No.: US 2015/0147920 A1
(43) Pub. Date: May 28, 2015

(54) CONNECTOR ATTACHABLE TO ANOTHER SAME CONNECTOR

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: YONG-CHANG FAN, Wuhan (CN)

(21) Appl. No.: 14/510,820

(22) Filed: Oct. 9, 2014

(30) Foreign Application Priority Data
Nov. 28, 2013 (CN) 2013106145758

(51) Int. Cl. H01R 13/506

(52) U.S. Cl. CPC H01R 13/506
USPC 439/701

(57) ABSTRACT

A connector includes a connecting interface and a connection piece. The connecting interface defines a socket for receiving a plug and includes a shell surrounding the socket. The shell defines a recess on an external surface of the shell. The connection piece is attached to the shell and is movable from a first position where the at least one connection piece is wholly received in the at least one recess to a second position where a part of the at least one connection piece is extended out of the at least one recess. The part of the at least one connection piece is configured to be received in a part of another recess of another connector to attach the connector to the other connector.

### CROSS-REFERENCE TO RELATED APPLICATIONS

This application claims priority to Chinese Patent Application No. 201310614575.8 filed on Nov. 28, 2013 in the China Intellectual Property Office, the contents of which are incorporated by reference herein.

### FIELD

The present disclosure relates to connectors attached to other connectors.

### BACKGROUND

Electronic devices include a number of connectors to connect a number interfaces. The connectors may be positioned at a number of slots or may be tied up together by a cord.

### BRIEF DESCRIPTION OF THE DRAWINGS

Implementations of the present technology will now be described, by way of example only, with reference to the attached figures.

FIG. 1 is an exploded isometric view of a connector.

FIG. 2 is an isometric view of the connector in FIG. 1, with a connection piece in a first position.

FIG. 3 is similar to FIG. 2, but with the connection piece in a second position.

FIG. 4 is an isometric view of two connectors attached to each other.

FIG. 5 is an isometric view of four connectors attached to each other.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

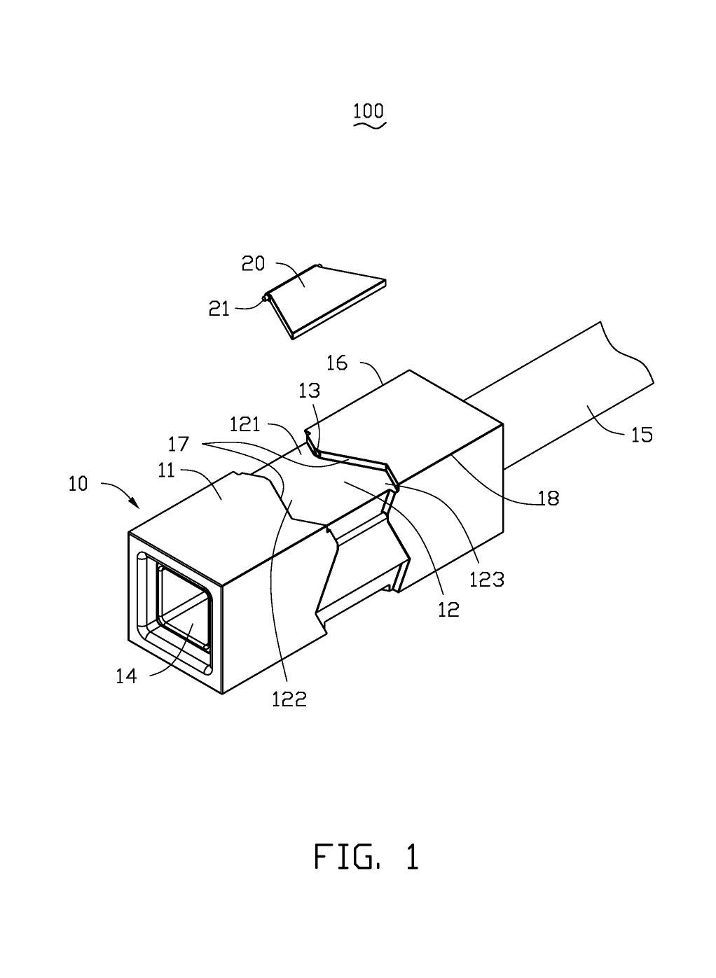

FIG. 1 illustrates that a connector 100 includes a connecting interface 10, a cable 15 and a number of connection pieces 20. The cable 15 is electrically connected to the connecting interface 10. The connection pieces 20 are configured to rotationally connect the connecting interface 10.

The connecting interface 10 includes four plates 11. The four plates 11 are perpendicularly attached one by one. The four plates 11 form a shell surrounding a socket 14, the socket 14 can receive a plug therein (not shown). The connector 100 includes four connection pieces 20 to be rotationally attached to four plates 11. The plate 11 includes a first edge 16 and a second edge 18 opposite to the first edge 16. The first edge 16 and the second edge 18 are substantially perpendicular to the socket 14. The plate 11 further includes two connection fringes 17 spaced from the socket 14. Two ends of the connection fringe 17 are positioned at the first edge 16 and the second edge 18.

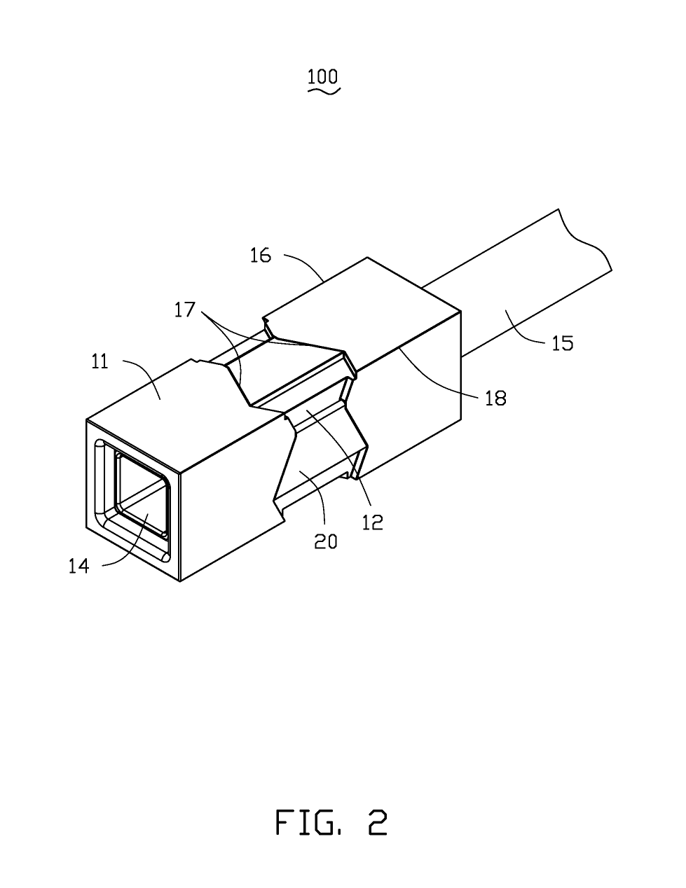

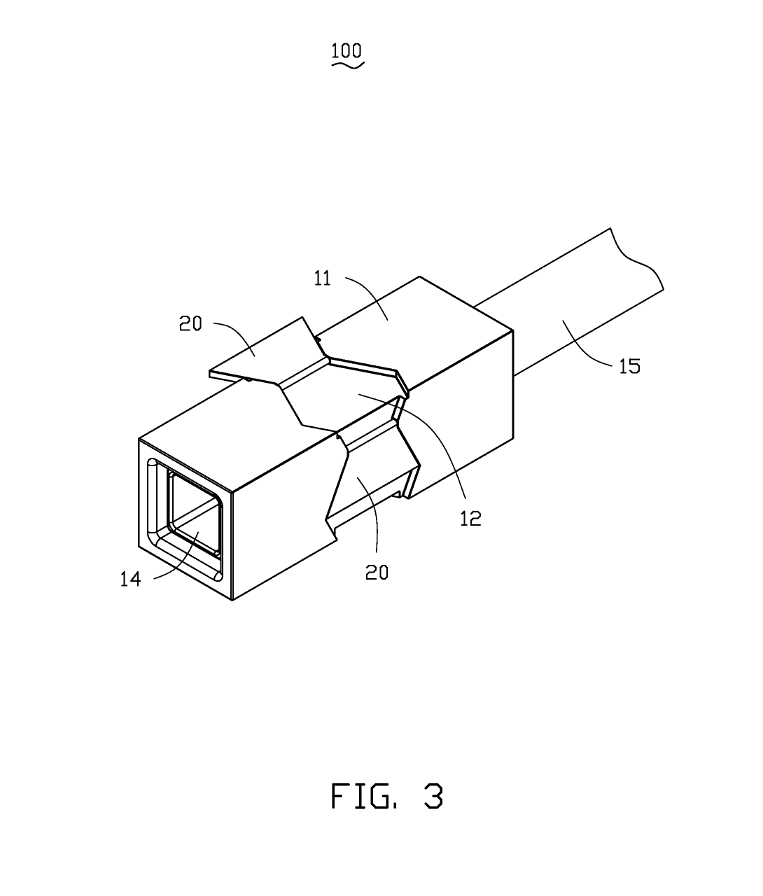

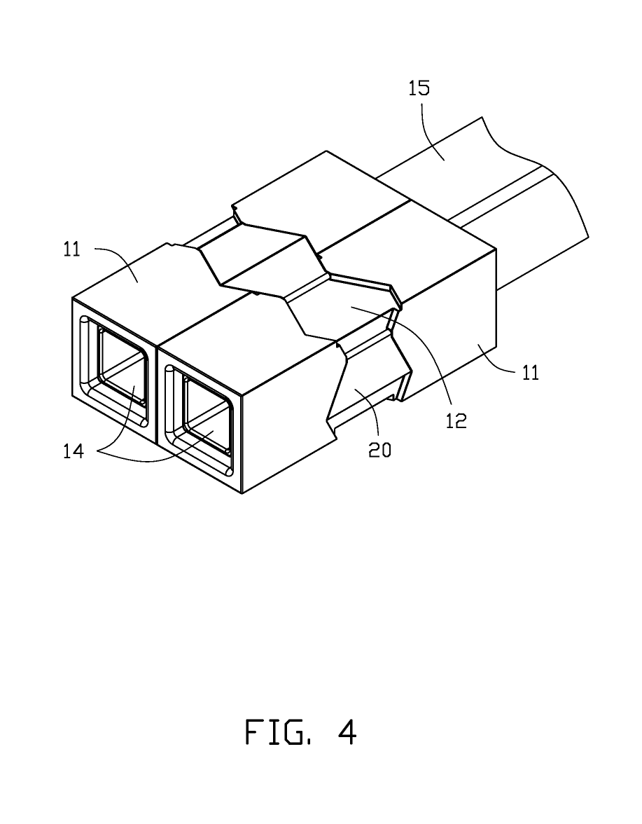

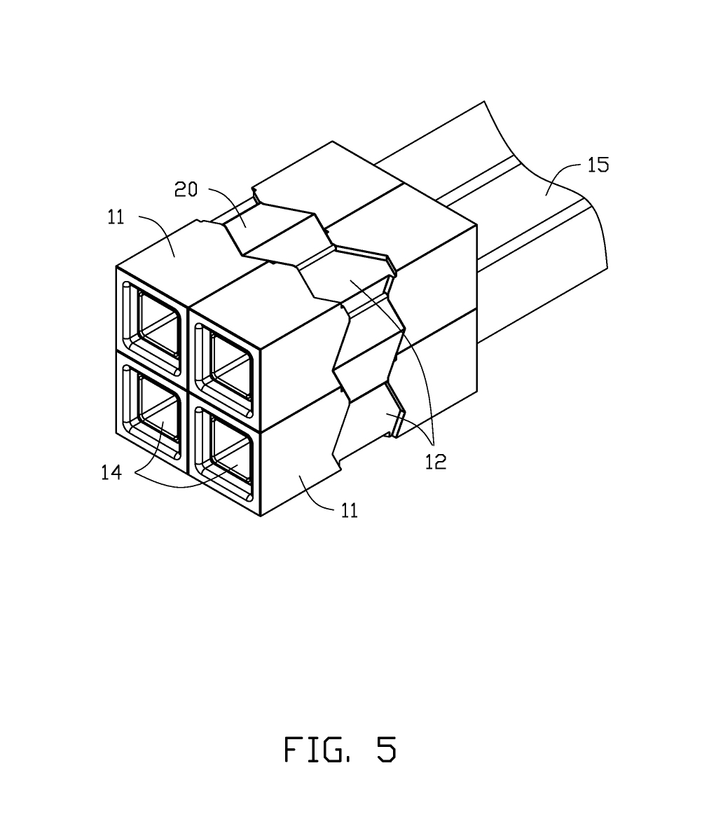

FIG. 2 illustrates that a recess 12 is defined between the two connection fringes 17. The recess 12 is configured to receive the connection piece 20. FIG. 3 illustrates that the connection piece 20 is attached to the two fringes 17 and is moveable from a first position where the connection piece 20 is wholly received in the recess 12 to a second position where the connection piece 20 is partly extending out of the recess 12. FIGS. 4 and 5 illustrate that when the connection piece 20 is partly extending out of the recess 12, the part of the connection piece 20 extending out of the recess can be received in a part of another recess 12 of another connector 100 to attach the connector 100 to the another connector 100. Thus, a number of connectors 100 can be attached together by the connection pieces 20 of the connectors 100.

In at least one embodiment, the two fringes 17 defines two opposite holes 13. The connection piece 20 includes a shaft 21. Two ends of the shaft 21 are rotationally received in the two holes 13.

The recess 12 includes a first recess 121, a second recess 122 and a third recess 123. The second recess 122 is arranged between the first recess 121 and the third recess 123. The first recess 121 and the second recess 123 can be shaped into the second recess 122. A size and a shape of the connection piece 20 is the same as the second recess 122. The connection piece 10 can be wholly received in the second recess 122. The connection piece 20 is rotatable 180 degrees around the shaft 21 to be partly extending out of the first recess 121. The part of the connection piece 20 extending out of the first recess 121 is configured to be received in another third recess 123 of another connector 100 to attach the connector 100 to the other connector 100.

In at least one embodiment, the first recess 121, the second recess 122 and the third recess 123 are three isosceles trapezoids. The top line of the first recess 121 and the top line of the second recess 122 overlap. The bottom line of the second recess 122 and the bottom line of the third recess 123 overlap. A length of the bottom line of the first recess 121 is same as that of the top line of the third recess 123. Thus, the first recess 121 and the second recess 123 can be formed to an isosceles trapezoid same as the second recess 122.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A connector comprising:
a connecting interface defining a socket for receiving a plug and comprising a shell surrounding the socket, the shell defining at least one recess on an external surface of the shell; and
at least one connection piece attached to the shell and movable from a first position where the at least one connection piece is wholly received in the at least one recess to a second position where a part of the at least one connection piece is extended out of the at least one recess, the part of the at least one connection piece configured to be received in a part of another recess of another connector to attach the connector to the another connector.

2. The connector as claimed in claim 1, wherein the connecting interface comprises at least one pair of opposite fringes, each recess is defined between a pair of fringes, each connection piece is rotationally attached to a pair of fringes.

3. The connector as claimed in claim 2, wherein each pair of fringes defines a pair of opposite holes, each connection piece comprises a shaft, two ends of each shaft are rotationally received in a pair of holes.

4. The connector as claimed in claim 2, wherein each recess comprises a first recess, a second recess and a third recess, the second recess is arranged between the first recess and the third recess, the connection piece is wholly received in the second received space and is rotatable to be partly received in the first recess, the other part of the connection piece is configured to be received in another third recess of the another connector.

5. The connector as claimed in claim 3, wherein the connection piece rotates 180 degrees around the shaft from the first position to the second position.

6. The connector as claimed in claim 4, wherein the first recess and the second recess can be shaped into the second recess.

7. The connector as claimed in claim 4, wherein a size and a shape of the connection piece is same as those of the second recess.

8. The connector as claimed in claim 6, wherein the first recess, the second recess, and the third recess are three isosceles trapezoids.

9. The connector as claimed in claim 1, wherein the shell includes four plates, the four plates are one by one perpendicular attached to define the socket.

10. The connector as claimed in claim 9, wherein each plate defines a recess, the connector comprises four connection pieces, the four connection pieces are received in the four recesses.

11. A connector comprising:
a connecting interface comprising a shell, the shell defining at least one recess on an external surface of the shell, an end of the shell being no-ended to from a socket; and
at least one connection piece, a size of the at least one connection piece being smaller than that of the at least one recess and wholly received in the at least one recess, the at least one connection piece being movable to be partly extended out of the recess to attach another connector by a part of the at least one connection piece extended out of the recess received in a part of another recess of the another connector.

12. The connector as claimed in claim 11, wherein the connecting interface comprises at least one pair of opposite fringes, each recess is defined between a pair of fringes, each connection piece is rotationally attached to a pair of fringes.

13. The connector as claimed in claim 12, wherein each pair of fringes defines a pair of opposite holes, each connection piece comprises a shaft, two ends of each shaft are rotationally received in a pair of holes.

14. The connector as claimed in claim 12, wherein each recess comprises a first recess, a second recess and a third recess, the second recess is arranged between the first recess and the third recess, the connection piece is wholly received in the second received space and is rotatable to be partly received in the first recess, the other part of the connection piece is configured to be received in another third recess of the another connector.

15. The connector as claimed in claim 13, wherein the connection piece rotates 180 degrees around the shaft from the first position to the second position.

16. The connector as claimed in claim 14, wherein the first recess and the second recess can be shaped into the second recess.

17. The connector as claimed in claim 14, wherein a size and a shape of the connection piece is same as those of the second recess.

18. The connector as claimed in claim 16, wherein the first recess, the second recess, and the third recess are three isosceles trapezoids.

19. The connector as claimed in claim 11, wherein the shell includes four plates, the four plates are one by one perpendicular attached to from the socket.

20. The connector as claimed in claim 19, wherein each plate defines a recess, the connector comprises four connection pieces, the four connection pieces are received in the four recesses.
